(19) United States
(12) Patent Application Publication
(10) Pub. No.: US 2006/0287022 A1
(43) Pub. Date: Dec. 21, 2006

(54) Method and system for supporting development of a common identity game

(76) Inventor: David H. Sitrick, Highland Park, IL (US)

Correspondence Address: SITRICK & SITRICK, 8340 N LINCOLN AVENUE SUITE 201, SKOKIE, IL, 60077, US

(21) Appl. No.: 11/513,549

(22) Filed: Aug. 31, 2006

Related U.S. Application Data
(63) Continuation of application No. 10/769,332, filed on Jan. 30, 2004.
(60) Provisional application No. 60/443,729, filed on Jan. 30, 2003.

(51) Int. Cl. A63F 13/00

(52) U.S. Cl. 463/1

(57) ABSTRACT

This invention relates to video games, their design, architecture, methodology, and more particularly to an architecture and methodology for providing interchangeable reward provision. The present invention provides for a nucleus of game application core and fixed image database and sound database, which are utilized in conjunction with interchangeable linked image databases including visual and sound, so as to permit a single video game design effort to have multiple lives and additional revenues.

### RELATED APPLICATIONS

This is a continuation application of application Ser. No. 10/769,332, filed: Jan. 30, 2004; which claims priority from the Provisional Application Ser. No. 60/443,729, filed: Jan. 30, 2003.

### FEDERALLY SPONSORED RESEARCH OR DEVELOPMENT

Not applicable.

### BACKGROUND OF THE INVENTION

This invention relates to video games, their design, architecture, methodology, and more particularly to an architecture and methodology for providing interchangeable reward provision.

In the past, each new video game system design required a total rewrite of a new game. Thus, each new video game provided, such as football gen 1, football gen 2, etc. would have a new game logic design put together, comprising application program, and imagery and sound created for that game. As the cost of developing video games has gone up from tens of thousands to millions of dollars per game, the risk of a bad game is more than nominal, it can be devastating. Thus, anything that can be done to spread the game development cost over future designs would be very beneficial. In addition, anything to increase revenues for a particular game further reduces the risk.

In the past, there have been the abilities to change players on teams, so that you can choose from predefined settings. Most recently, you can add characters to be interchanged as players, so that you can choose the football or baseball team. This is consistent with the teachings of present applicant's earlier issued patents, including the U.S. Pat. No. 4,521,014; U.S. Pat. No. 5,553,864; U.S. Pat. No. 5,830,065; and U.S. Pat. No. 6,425,825 patents.

Thus, it is an object of the present invention to provide for a nucleus of game application core and fixed image database and sound database, which are utilized in conjunction with interchangeable linked image databases including visual and sound, so as to permit a single video game design effort to have multiple lives and additional revenues.

### SUMMARY OF THE INVENTION

In accordance with one aspect of the present invention, a video game architecture, system and methodology are provided wherein a core game application logic provides video game logic and a predefined set of visual and audio imagery and a fixed database image-mapper for providing control for managing and selecting video and audio imagery from a combination of a core image database comprising a fixed portion (CIDF) and a variable portion (CIDV) which together form the complete audio/visual presentation associated with the video game, movie, or other interactive entertainment.

Additionally, a linked image database (LID), or a plurality of image linked databases provide the variable audio and visual images in the linked video game operation, permitting update of reward content and audio/visual content otherwise associated with the video game to be replaced, while retaining the core video game rules and identifiable logic, and perhaps a portion of the original audio/visual imagery, that portion being variable from minimal to a considerable amount depending on the designer's choices.

Thus, music videos, movie trailers, even television commercials that are music video advertisements, can all be linked and updated into the video game. Each time a new video game in a new packaging can be sold as a separate new video game comprising the core game application software (CGS), including the image-mapper (IM), the core image database (CID) comprising the core image database fixed portion (CIDF) and the core image database variable portion (CIDV). The CGS and CID are provided in common on all of the game family members sharing the common identity, and each separate CD or video game package provides the linked image databases and the linked databases index needed to provide an integrated video game system. As used herein, video game system is not limited to, and extends to all formats of home entertainment including home video game systems such as the SONY Playstation, Nintendo Cube, or Microsoft Xbox, and further includes use of CDs and DVDs in personal computers running any operating system (including Windows, LNUX, MacIntosh, or other computer operating system) Web-TV, etc. The linked image databases (LID) can be provided via flashRAM, ROM, CDROM, DVD, hard disk, provided responsive to user generation, via online download, etc.

The linked image databases (LID) and the linked database index (LDI) are utilized by the image-mapper to integrate a combination of the core image database and the linked image database or databases into the core game application software to provide the video/audiovisual entertainment product. For example, the linked image database can be music videos and each separate database can represent a genre such as rap, classic rock, 60's pop, 70's pop, 80's pop. Or, it can be comprised of movie trailers for various types of movies including action, romance, chick-flicks, guy-flicks, etc. Or, it can be comprised of specialty videos, such as cooking, karaoke, dance, etc. Additionally, utilizing audio-visual works produced by businesses as advertisements can be provided such that Superbowl ads and Academy Award television advertisements can be utilized to segue way between elements of the game, and generate additional source of revenue for the game manufacturer. Thus, a common single development of a core game application software product and core image database, with associated image-mapper, and CID fixed and CID variable portions, can be re-utilized to create a family of entertainment products, such as video games, utilizing a common identity CGS and CID, but with each member of the family utilizing a different set of linked image database and linked database index therefor.

The linked database index for each of the linked image databases is preferably loaded into local RAM memory of the computing system processing and running the video game, but can also utilize remote indexes as appropriate, such as where online linkage is provided for the video game system to provide for online updates of linked image databases and linked database indexes associated therewith, to provide for easier updates. Accounting can be provided to charge the user, such as directly to a charge card (e.g. Visa, Master Card, American Express, Discover) which also permits updates of advertising LIDs. Thus, the audio-visual imagery and rewards change within a family, but the basic game rules and game play stays consistent within the family. Thus, all the benefits of learning and mastering a game and going to higher levels are maintained, and the user continues to benefit from their experience level. Secondly, since during the play of the game you often have to repeat the lower levels, it adds a whole new level of interest to the game to be able to be provided with new audio-visual imagery for providing the same winning moves, creating a whole new experience in playing that game. This can be done with different types of audio-visual game imagery, or can be provided with other types of audio-visual imagery as a reward, such as music or dance videos, exercise videos, movie trailers, any sort of audio-visual presentation, so forth.

In one preferred embodiment, the video game is provided in a musical environment, and the LID and LDI are provided as music videos, movie trailers, ads, and interactive performance of a user-created music composition by a “star” or “stars”, musical group. This could be especially beneficial as a reward system in a video game based music education and training system and methodology. In this embodiment, the elements already present in the video game system, such as a Playstation, etc., are utilized as the processing system, user interface and display generation system. Specific core game application software is written for the target genre of game, such as musical education, role-playing game, action game, mystery, etc. As a part of the core game application software logic and development, image-mapper logic is provided which defines specific locations in the core game application software utilizing image database content. The image-mapper controls the selection process from the core image database, either fixed or variable portion, as well as to the linked image database or databases via the linked database indexes associated with each of the linked image databases. Control logic provided by the image-mapper software manages indexing and accessing images as necessary to provide the audio/visual imagery and rewards for each unique member of the family.

In one embodiment, the image-mapper provides the linked database index (LDI) as a pointer to the proper location in the linked image database (LID) from the appropriate respective location in the CIDF or CIDV. Variables within the linked image database are logically indexed in the linked database index according to assignment to variable names, and the pointer in the core image database provides as its variable data the variable name to point to the entry in the linked database index. The linked database index provides a mapping from the variable name to the specific location of the associated audio and visual images needed to provide the necessary audio/visual content to the image-mapper to integrate into the generation of the video game or other entertainment system presentation output.

A video game system provides a display presentation for a video game. The system is comprised of core game application logic, a core image database, and an image-mapper. The core game application logic provides video game logic and respective display presentation therefor as associated with the video game, The core image database comprises a core set of video image data and audio image data in a structure comprising a core image database fixed portion (CIDF) and a core image database variable portion (CIDV). The image-mapper provides control for managing and selecting of video image data and audio image data from a combination of the core image database fixed portion (CIDF) and the core image database variable portion (CIDV), to provide all content needed to provide the display presentation, responsive to the core game application logic. In one embodiment, a fixed database is provided comprising a pre-defined set of video image data and audio image data. In this embodiment, the image-mapper provides control for managing and selecting of video image data and audio image data from a combination of the fixed database and the core image database, to provide all content needed to provide the display presentation, responsive to the core game application logic.

In a preferred embodiment, the system is further comprised of a linked image database (LID), providing variable audio image data and variable video image data. The image mapper provides for replacement of the video image data and audio image data from the combination of the fixed database and the core image database, as otherwise associated with the video game, with variable audio image data and variable video image data from the linked image database, while retaining the video game logic therefore as associated with the video game. In one embodiment, the system is further characterized in that said linked image database (LID) has an associated linked databases index utilized by the image-mapper to integrate a combination of the core image database and the linked image database product. In a preferred embodiment, there are a plurality of linked image databases (LID) wherein each of said linked image database (LID) has an associated linked databases index utilized by the image-mapper to integrate a combination of the core image database and the linked image database product to provide an integrated video game with an associated integrated display presentation. To facilitate family or genre core game design, the linked image database and the Mapping Index (or the linked database index or the CID Index) for each video game is provided as stored content separate from the core image database. The stored content is preferably provided on a non-volatile storage medium, such as semiconductor memory (e.g. EEPROM, EPROM, Flash Ram, CD-Rom, DVD, hard disk, etc.).

In a preferred embodiment, the linked image databases (LID) and the linked database index (LDI) (or other Mapping Index) are utilized by the image-mapper to integrate a combination of the core image database and the linked image database product to create the display presentation uniquely for each of the combinations. The linked image database can be representative of music videos, movie trailers, specialty videos, is representative of advertisements utilized to transition between active play segments of the display presentation for the video game, and so forth.

In a preferred embodiment, a Mapping Index defines the mapping of the Linked Image Database (LID) into the core image database variable portion (CIDV). In one embodiment, the Linked Image Database (LID) is coupled to the system via online linkage to provide for online integration and mapping of the Linked Image Database (LID) into the core image database variable portion (CIDV) responsive to the Mapping Index. The core application logic selectively updates via the online linkage substituting the core image database variable portion (CIDV) with the Linked Image Database (LID) responsive to the Mapping Index. Alternatively or additionally, the core application logic selectively updates via the online linkage substituting the core image database variable portion (CIDV) with the Linked Image Database (LID) responsive to the Mapping Index.

Since the family of games reutilizes a core portion of logic and audiovisual content, the basic game rules and game play stays consistent for all games within the same family of games, with only the display presentation changing, responsive to the integrating of the audio and/or video content from the Linked Image Database (LID.

The change in the display presentation provides at least one of new audio, video and audiovisual content in the display presentation responsive to the substituting and to the core game logic. The new audio, video and audiovisual content in the display presentation is at least one of a reward, an advertisement, a substitute character, additional scenery, weapons, clothing, and vehicles. The new audio, video and audiovisual content in the display presentation is at least one of additional video imagery, additional audio content, and additional audiovisual content. In a preferred embodiment, the reward is at least one music, music video, dance video, exercise video, movie trailers, animated short, an interactive performance of a user input based music composition performance, and a change of at least one color in the display presentation of the video game. In one embodiment, the interactive performance is of a user-created music composition is provided by at least one third party performer (e.g. recording star or stars, movie stars, etc.). In an alternate embodiment, the reward is utilized to facilitate music education.

In a preferred embodiment, the video image data and audio image data are grouped into one of game play content and reward content. The display presentation is provided responsive to at least one of the game play content and the reward content.

In one embodiment, the display presentation is provided responsive to the game play content (e.g. non-reward content) until a reward threshold is reached, and the display presentation is provided responsive to the reward content for a defined period of time responsive to the reward threshold being reached. The reward content can be comprised one or more of music videos, movie trailers, television commercials, an audiovisual presentation, and audio presentation, and a change in game play appearance.

The linked image database can be selected from among a family of a plurality of interchangeable linked image databases to provide a plurality of video games all with a common family core game operability and identity and each with a different appearance in the display presentation responsive to the linked image database.

The linked image database is utilized to change the underlying audiovisual imagery associated with normal game play that would occur absent the content of the linked image database. The linked image database can provide additional said content beyond the content associated with regular game play, or substitute content for that otherwise associated with game play, or additional content not associated with game play.

Thus, the linked image database can be associated with a reward beyond the normal audiovisual game imagery. In a preferred embodiment, the core image database variable portion (CIDV) is associated with a reward beyond the normal audiovisual game imagery.

The display presentation is comprised of a game portion associated with normal audiovisual game imagery and a reward portion associated with a reward beyond the normal audiovisual game imagery. Integration of said linked image database (LID) into the display presentation creates an associated new appearance video game responsive to the video game logic of the core game application logic.

In a preferred embodiment, there are a plurality of separate ones of said linked image database each structured for integration of any one of the plurality of said linked image databases (LID) into the display presentation a video game consistently responsive to the video game logic of the core game application logic for each of the plurality of said linked image databases (LID) and wherein each of said plurality of said linked image databases (LID) creates an associated new appearance to the display presentation of the video game responsive to the core game application logic. In one embodiment, the core game application logic is utilized to support a common identity game structure supportive of a common single development environment utilizing a core game application software with the image-mapper and the core image database fixed portion (CIDF), utilized in conjunction with the core image database variable portion (CIDV) to provide all content needed to provide the display presentation. The core image database variable portion (CIDV) provides a CIDV Index defining the mapping into core image database variable portion (CIDV) to provide for integration of a Linked Image Database (LID) providing LID video image data and LID audio image data utilized in creating a reusable video game core. Where there are a plurality of the Linked Image Databases (LIDs), the system provides for a family of a plurality of video game entertainment products, each of the plurality utilizing the common identity game structure supportive of a common single development environment with each of the plurality utilizing a different one of the plurality of the Linked Image Databases (LIDs) responsive to the CIDV Index.

The core system comprised of core game application logic, a core image database, and an image-mapper is in one embodiment further comprised of a Linked Image Database (LID) providing LID video image data and LID audio image data, wherein the core game application logic is utilized to support a common identity game structure supportive of a common single development environment utilizing a core game application software with the image-mapper and the core image database fixed portion (CIIDF), utilized in conjunction with the core image database variable portion (CIDV) to provide all content needed to provide the display presentation. The Linked Image Database (LID) provides a LIDV Index defining the mapping of the Linked Image Database (LID) into the core image database variable portion (CIDV) to provide all content needed to provide the display presentation. Where there are a plurality of the Linked Image Databases (LIDs), the system provides for providing a family of a plurality of video game entertainment products, each of the plurality utilizing the common identity game structure supportive of a common single development environment with each of the plurality utilizing a different one of the plurality of the Linked Image Databases (LIDs) responsive to the LIDV Index.

The video game system has a processing system including local memory (e.g. personal computer, game console (e.g. Sony Playstation, Nintendo Game Cube, Microsoft X-box, Nintendo Game-Boy), wherein the LIDV Index for the Linked Image Database (LID) is loaded into the local memory of the system to facilitate selective mapping the Linked Image Database (LID) into the core image database variable portion (CIDV) as needed to provide content needed to provide the display presentation.

The core system comprised of core game application logic, a core image database, and an image-mapper is in one embodiment further comprised of a Linked Image Database (LID) providing LID video image data and LID audio image data. The core game application logic is utilized to support a common identity game structure supportive of a common single development environment utilizing a core game application software with the image-mapper and the core image database fixed portion (CIDF), utilized in conjunction with the core image database variable portion (CIDV) to provide all content needed to provide the display presentation. An external source (or the CID or LID or core application logic) can provide a Mapping Index defining the mapping of the Linked Image Database (LID) into the core image database variable portion (CIDV) to provide all content needed to provide the display presentation.

In one embodiment, the core application logic is comprised of core game application software structured for a target genre of video game. The target genre can be one or more of musical education, role-playing game, action game, mystery, war-game, dance game, sports game, and simulator game.

In a preferred embodiment, the core game application software is comprised of image-mapper logic. The image-mapper controls the selection process from the core image database fixed portion (CIDF), the core image database variable portion (CIDV) and the Linked Image Database (LID) to provide all content needed to provide the display presentation. A Mapping Index defines the mapping of the Linked Image Database (LID) into the core image database variable portion (CIDV), wherein the image-mapper logic is responsive to the Mapping Index. In one embodiment, the image-mapper logic provides for managing, indexing and accessing content from at least one of the core image database fixed portion (CIDF), the core image database variable portion (CIDV) and the Linked Image Database (LID) to provide all content needed to provide the display presentation. In one embodiment, the image-mapper logic provides a pointer to a proper location in the Linked Image Database (LID) from a respective location in at least one of the core image database fixed portion (CIDF), the core image database variable portion (CIDV) responsive to the Mapping Index. In one embodiment, the Mapping Index is provided by the Linked Image Database (LID), wherein LID variables each having a LID variable name are provided within the Linked Image Database (LID) and are logically indexed in the Mapping Index according to the LID variable names, wherein a pointer in the core image database (CID) provides a CID variable name to point to a respective one of the LID variable names in the Mapping Index. In this embodiment, the Mapping Index provides for a mapping from the CID variable name to the respective one of the LID variable names to provide for selectively obtaining audio, video and audiovisual content from the Linked Image Database (LID) for use by the image-mapper logic for integration and use in providing the presentation output.

In accordance with the present invention, there is also taught a method for providing a display presentation for a family of interrelated video games. The method comprises providing video game logic and a respective display presentation therefore as associated with the video game, providing a core image database comprising a core set of video image data and audio image data in a structure comprising a core image database fixed portion (CIDF) and a core image database variable portion (CIDV); and, providing image-mapper control for managing and selecting of video imager data and audio imager data from a combination of the core image database fixed portion (CIDF) and the core image database variable portion (CIDV), to provide all content needed to provide the display presentation, responsive to the video game logic. In a preferred embodiment the method is further comprised of providing a linked image database (LID), comprising variable audio image data and variable video image data. The image mapper control provides for replacement of the video image data and audio image data from the combination of the fixed database and the core image database, as otherwise associated with the video game, with variable audio image data and variable video image data from the linked image database, while retaining the video game logic therefore as associated with the video game. In accordance with one aspect of the present invention, said linked image database (LID) has an associated linked databases index utilized by the image-mapper to integrate a combination of the core image database and the linked image database product.

### DETAILED DESCRIPTION OF THE DRAWINGS

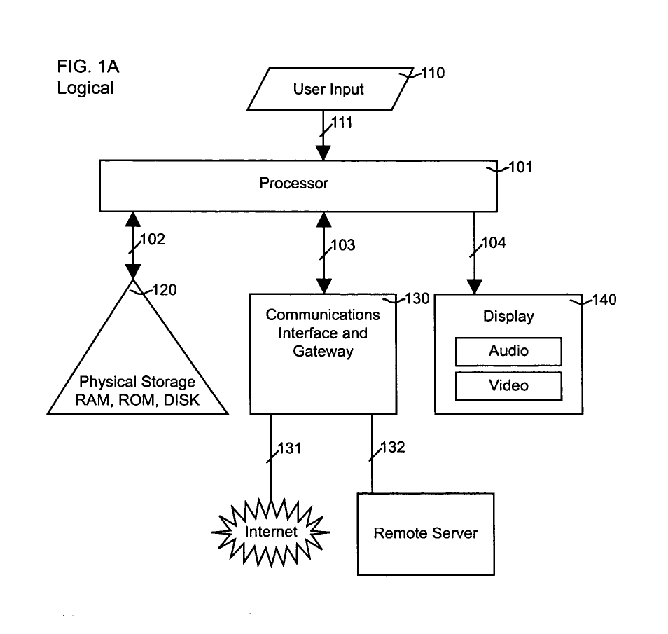

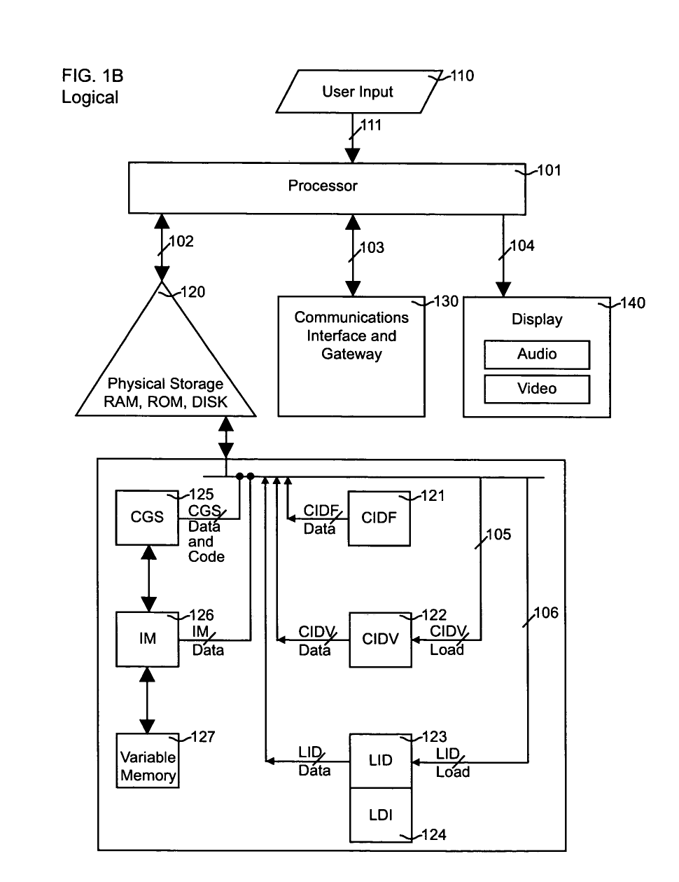

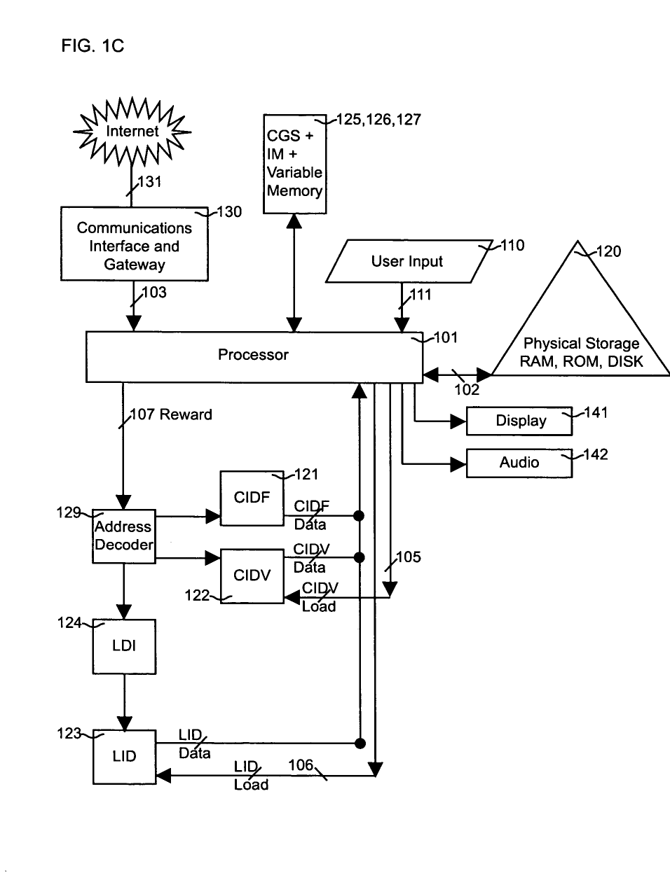

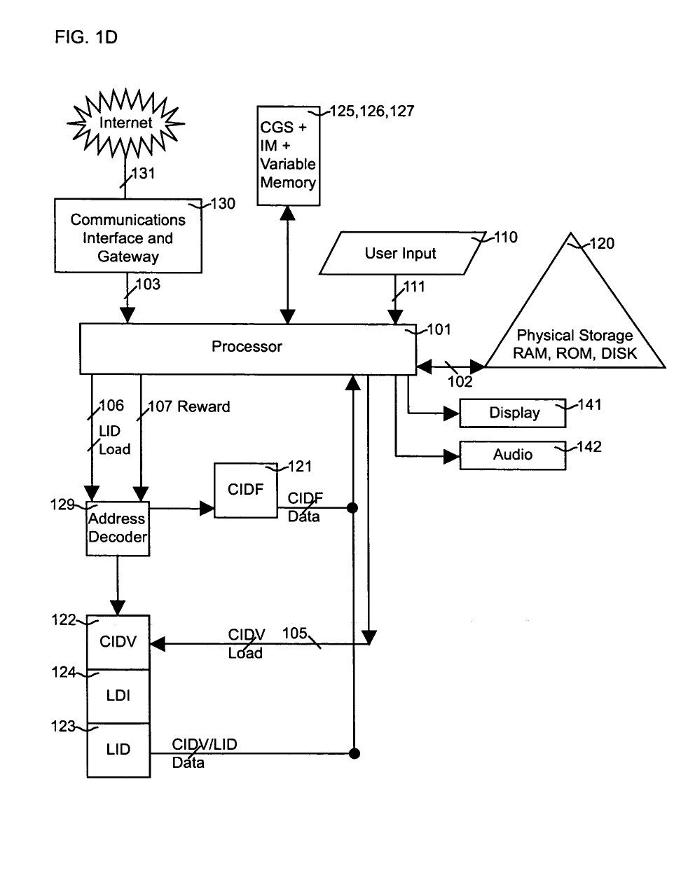

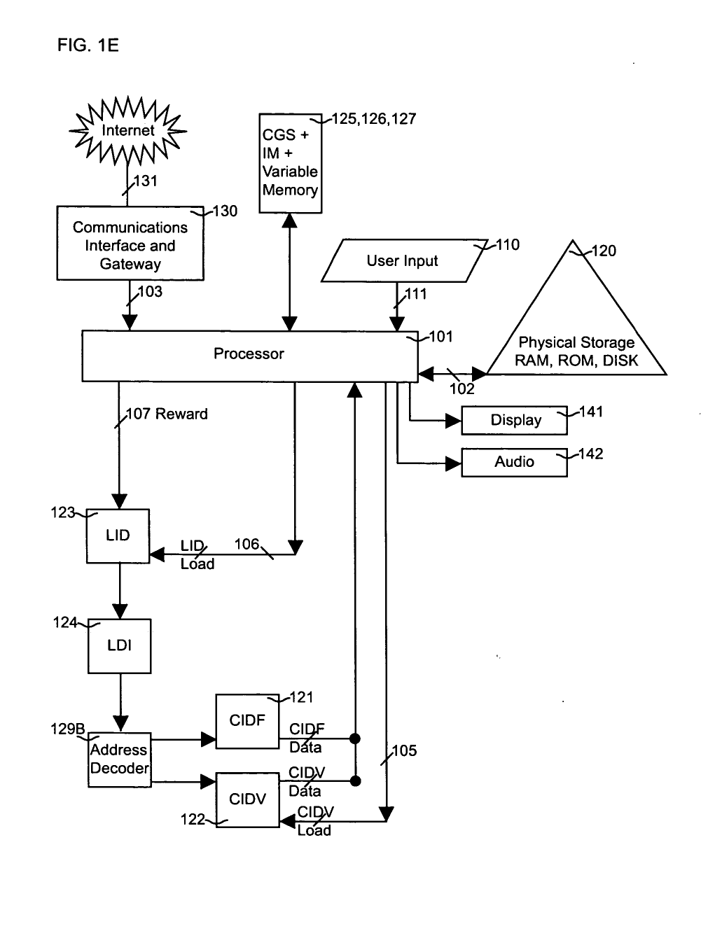

Referring to FIG. 1A, a system block diagram of the physical hardware required to implement one embodiment of the present invention are illustrated. A processor (101) is coupled to user input (110) via connection (111), a physical storage (120) via coupling (102), communications interface logic and gateway (130) coupled via coupling (103), and coupled to the Internet through coupling (131) and to a remote server through coupling (132). The display (140), comprising video and audio components, are illustrated coupled to the processor (101) via coupling (104). The processor (101) executes the core game application software and associated image mapping logic, as well as responsive to control logic stored in the physical storage, as well as providing for audio and visual imagery within the presentation on the display (140) by means of integrating image data from the physical storage (120) and/or via the communications interface in gateway (130), such as via the Internet or from a remote server.

Referring to FIG. 1B, the logical structuring, architecture and data flow are illustrated with reference to the physical system block diagram of FIG. 1A. The processor (101) is coupled to the storage (120) both for access to computer core game application software as well as for the various image software data needed to construct the various audio and visual images that go along with the application software logic and control. As shown in FIG. 1B, the storage (120) via coupling (102) couples to the processor (101) and provides coupling to the core game software (125), the image mapping logic (126), and variable memory (127), as well as providing access, control and management of the core image database fixed portion (121) and core image database variable portion (122), and to the linked information database (123) and linked database index (124). The processor (101) communicates via coupling (102) with the core game application software (125) and associated image-mapper logic (126) and responsive thereto accesses the variable memory (127) and causes the processor to access the core image database fixed, (121), core image database variable, (122) and linked image database (123) in association with the linked database index (124) to provide for compositing of an integrated video game. The linked information database (123) and linked database index (124) can be interchanged for different sets of LID (123) and LDI (124) so as to provide a family of games sharing a common core and nucleus of both technology hardware and software as well as operational logic and game play. In one embodiment, the core image database variable (122) and linked image database (123) are loaded into local memory of the system responsive processor control signals (105) (CIDV load) and (106) (LID load). The loading of the linked image database also loads the linked database index which can be utilized in combination with the LID to provide quick mapped access to particular image variables defined by the core family logic, especially the CGS (125), IM (126) and variable memory (127) utilized thereby.

Referring to FIG. 1C, there is illustrated an alternate embodiment of the physical/logical operation of the systems of FIGS. 1A and 1B. In the illustrated embodiment of FIG. 1C, the processor (101), responsive to the user input (110) and through coupling (111), accesses the storage (120) via coupling (102), and responsive to the CGS (125), image-mapper (126), and variable RAM (127), in conjunction with the core image database fixed (121) and core image database variable (122) and linked image database (123), provides a video game for play by the user and provides an output video display (141) and audio display (142) responsive thereto. The user input (110) can be a keyboard, mouse, joystick, or any other user input device permitting users to provide control signals to the processor (101). The communications interface (130/131) provides coupling to the Internet by the processor for loading data to the processor to be utilized in loading into the various layers of storage (120) including CIDV (122) and LID (123). As illustrated in FIG. 1C, a reward signal output (107) from processor (101) is coupled to an address decoder (129) which responsive thereto causes addressing and read signals to be sent to the respective image database (CIDV 122, CIDF 121, or LID 123). Signals to the LID (123) are first coupled into the LDI (124) for variable to physical address mapping to provide an output from LID (123) of LID data which couples back to the processor (101). Alternatively, where the address decoder (129) determines that the audio and/or visual imagery needed is in the core image database, it appropriately selects and causes output from CIDF (121) or CIDV (122).

Referring to FIG. 1D, an alternative embodiment of FIG. 1C is illustrated, wherein the LDI (124) and LID (123) are integrated into the CIDV (122) logic to provide a combined integrated output. As illustrated in FIG. 1D, the address decoder (129) output is coupled to either the CIDF (121) or to the combined CIDV/LDI/LID (122, 124 and 123 respectively). Responsive to the signal from the address decoder (129), the appropriate CIDF data or CIDV/LID data is output for coupling to the processor (101) for utilization in generating the audio visual presentation output on the visual display (141) and the audio display (142). In a preferred embodiment, the CIDV image database is utilized as a default when there is not LDI/LID database. Alternatively, variable LID/LDI databases can be utilized with every game in the family.

Referring to FIG. 1E, an alternative embodiment to FIGS. 1C and D are illustrated, wherein the architecture is slightly altered. The output reward (107) from the processor (101) is coupled directly to the linked image database (123), which is coupled to provide a linked database index to the address decoder (129B), which provides a respective output to one of the core image database fixed (121) or core image database variable (122), which provide a respective output of CIDF data or CIDV data to the processor (101) responsive thereto. The linked image database data is loaded into the CIDV (122) as part of an initialization process in this architecture, so that the linked image database and linked database index thereafter provide the necessary additional mapping, in addition to the image mapping (126), necessary to provide for an integrated operation for each video game for a family of related games.

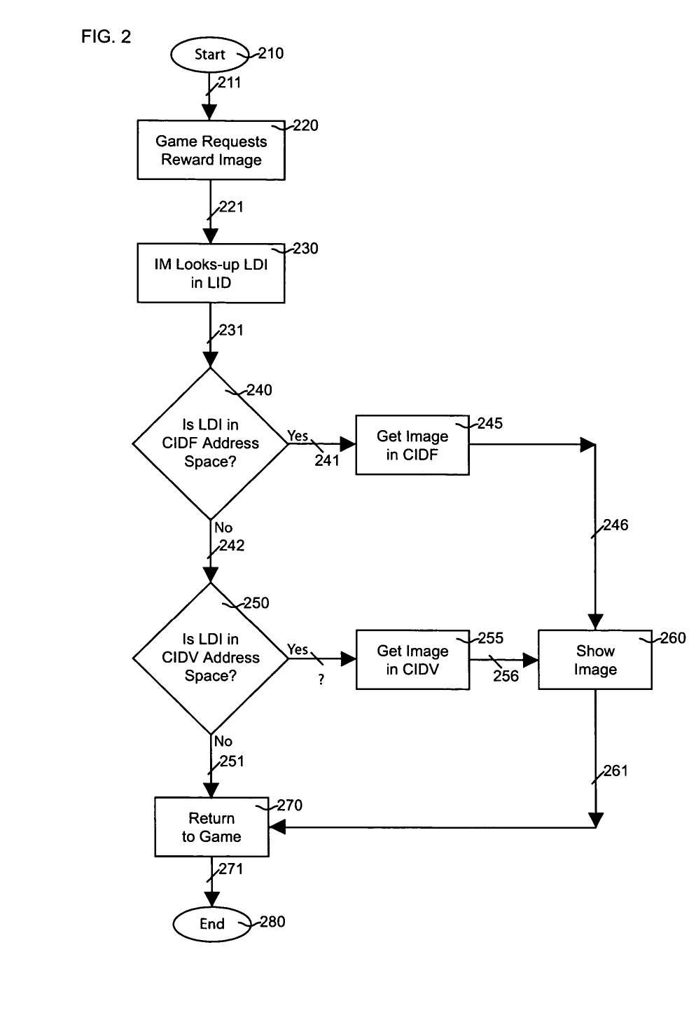

Referring to FIG. 2, one embodiment of the processing flow and methodology associated with one aspect of the present invention is as shown in FIG. 1E illustrated. The process starts at (210), and game control logic processes the data to generate a video game play responsive to the user input, up to the point where the game requests a reward image at step (220). Proceeding to step (230) the image-mapper looks up the linked database index in the linked image database. A decision is made at step (240) as to whether the linked database index is in the core image database fixed address space. At (241) decision is made that “yes” and at step (245) the image in the CIDF is obtained. From here, processing proceeds to integrate the image obtained into the audio/visual presentation of the video game at step (260) and returns to the video game at step (270) whereafter the process ends at (280). Alternatively, if at step (240), it is determined that the linked database index is not in the CIDF address space, at step (242), then a second decision is made at step (250) as to whether the linked database index is in the core image database variable address space. If “yes”, processing proceeds at step (255) to get the image from the CIDV and proceeds at step (256) to step (260) to actually integrate the image data into the audio/visual presentation of the video game, whereafter processing continues to return the video game at step (270) and the integration ends at step (280). Alternatively, if the linked database index is not in the CIDV address space, then processing returns to the game at step (270) and the image mapping and linking ends at step (280). As illustrated, FIG. 2 correlates to the illustrated embodiment of FIG. 1E. It is to be understood that the equivalent process flow can be utilized for the other embodiments illustrated in FIGS. 1A-1D.

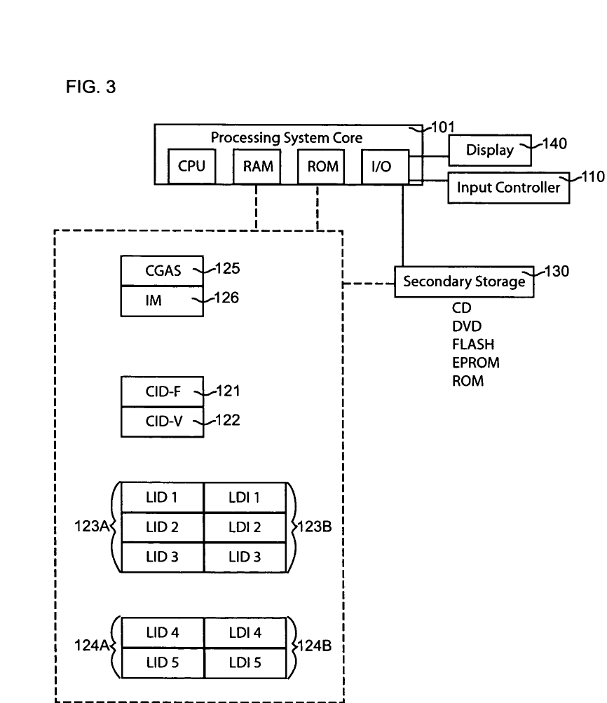

Referring to FIG. 3, a mapping of the hardware elements of FIGS. 1A-E is correlated to the actual stored elements locations in the physical architecture to the logical architecture. As illustrated in FIG. 3, the processing system (101) is further comprised of a CPU, RAM, ROM and I/O. The I/O is coupled to provide output the display (140) to provide an audio/visual presentation, to an input controller (110) to provide coupling of user input stimulus back to the processing system (101), and to a secondary storage (130) to provide coupling of disk, CD (compact disc), digital video disk (DVD), flashRAM, EPROM, ROM, or other storage means. The processing system ROM, RAM, and the secondary storage provide the necessary locations for maintaining the core game application software (125) and associated image mapping logic (126), the CID-F (121) and CID-V (122), and one or more sets of LID/LDI (123/124). As illustrated in FIG. 3, a first set of LID and LDIs (123A and 123B) are illustrated comprising LID Set 1 with associated LDI 1, LID Set 2, with associated LDI 2, and LID Set 3, with associated LDI 3.

As an example, LIDs may be related to rewards such as music videos or movie trailers, or film clips, or audio clips, and may also be new audio visual imagery for background play unrelated to rewards to change the appearance of the underlying core game. Additionally as shown in FIG. 3, a second set of LID/LDI (123B/124B), which can be different set for different member of the family. These can be provided on separate mediums, such as providing the CGAS (125), IM (126), CIDF (121), CIDV (122), on a core CD, and providing update RAMs, ROMs, or CDs for each linked image data and linked data index set. Alternatively, all of the core elements can be included on a single CD which also has one or more LID/LDIs, and each CD provided with a different set of LID/LDIs to create a separate member of the family which stands alone. Additionally, LID/LDIs can be provided via Internet or otherwise.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed is:

1. A method for supporting a common identity game, the method comprising:
providing a common development environment comprising Core Game Application Logic, Core Game Application Software comprising an image mapper, a Core Image Database (CID) comprising a Core Image Database Fixed (CIDF) portion and a Core Image Database Variable (CIDV) portion, and a CID Index defining mapping of the CID for integration into a display presentation, wherein the CID is utilized by the core game application software to generate a display presentation responsive to the image mapper and the CID Index;
providing a separate Linked Image Database (LID) for each of a plurality of people;
wherein the image mapper is responsive to the plurality of respective LID's to define mapping of selected parts of the respective ones of the LIDs, to a respective CID portion responsive to the CID Index and the plurality of LIDs; and
wherein the Core Game Application Logic is responsive to the image mapper, the CID, the and CID Index and the plurality of LIDs to provide for generation of a display presentation for the common identity game.

2. The method as in claim 1, wherein the common identity game provides for a plurality of related game display presentations, each constructed utilizing the CID and utilizing a different respective one of the LIDs.

3. The method as in claim 1, further comprising:
providing a Linked Database Index (LDI) associated with each respective one of the LIDs, each said LDI defining mapping of the respective LID;
providing a common identity to the display presentation for each of the plurality of related game display presentations;
wherein there is a first LDI associated with the CIDV; and
wherein each of the multiple LDIs is equal to the first LDI.

4. The method as in claim 1, further comprising:
providing content for at least a part of at least one of a respective CID and a respective LID, coupled from a respective remote location to a common host system from each of a plurality of the people;
integrating the respective content from the plurality of programmers, to create the common identity game responsive to the core game application software utilizing the CID Index; and
selectively mapping at least one of the LIDs into at least one of the CIDF portion and the CIDV portion, responsive to the CID Index, to provide content for the display presentation.

5. The method as in claim 4, further comprising:
selectively mapping from the plurality of the LIDs into the CID, responsive to the core game application software, to generate a single integrated video game display presentation.

6. The method as in claim 1, wherein image-mapper controls the selection process from the CIDF portion, the CIDV portion and the LID to provide all content needed to provide the display presentation.

7. The method as in claim 5, selectively mapping from the plurality of the LIDs into the CID, responsive to the core game application software to generate a plurality of common identity games having an associated common identity portion of an integrated video game display presentation, wherein each of the plurality common identity games also has a unique portion of the display presentation integrated into the respective video game display presentation.

8. The method as in claim 1, further comprising:
providing a mapping index defining the mapping of the respective one of the LIDs into the CID portion,
wherein the image-mapper is further responsive to the mapping index,
wherein the mapping index is provided by the LID, providing a plurality of LID variables each having a LID variable name within the LID; and
indexing the LID variable names in the mapping index providing a pointer to a CID location in the mapping index, associated with a respective one of the LID variable names.

9. The method as in claim 1, wherein the image-mapper maintains a record of mapping usage to provide for accounting of usage of respective portions of the CID and the LID.

10. The method as in claim 1, wherein the plurality of people are at least one of artists, programmers, game developers, game producers, and game players who contribute a respective LID utilized to provide at least a part of the video display presentation for a multiplayer online video game for play by a plurality of people who are game players.

11. The method as in claim 11, wherein the mapping index provides for a mapping from the CID to the respective one of the LID variable names to provide for selectively obtaining content from the LID for use by the image-mapper logic for integration and use in providing the display presentation.

12. The method as in claim 1, further comprising:
hosting the common development environment on a processing system;
downloading the plurality of LIDs and associated LDIs from the plurality of people from remote locations to the processing system; and
integrating the plurality of LIDs and the CID into a video game display presentation.

13. The method as in claim 1, further comprising:
selectively updating at least one of said LIDs via on-line linkage; and
providing new content for integration, responsive to the image-mapper, into a respective selected portion of the display presentation as at least one of a reward, an advertisement, a substitute character, additional scenery, weapons, clothing, vehicles, music, music video, dance video, exercise video, movie trailers, animated short, an interactive performance of music composition performance, and a change of at least one color in the display presentation of the video game, responsive to the updating.

14. A system providing a structure supportive of a video game entertainment product having an associated display presentation, the system comprising:
a core subsystem comprising Core Game Application Logic (CGAL), a Core Image Database (CID), and an image-mapper;
memory for storing a Linked Image Database (LID) having an associated Linked Image Database Index (LDI) defining the mapping of the Linked Image Database (LID) into the Core Image Database (CID);
a communications interface for coupling of an LID from a remote location for storage in the memory; and
wherein the Core Game Application Logic supports a common identity game structure supportive of a common single development environment utilizing the core game application software, responsive to the image-mapper responsive to the LDI, the CID and the LID, to provide the display presentation.

15. The system as in claim 14, further comprising:
a plurality of local processing subsystems, each of the plurality of local processing subsystems having an associated respective one of a plurality of separate locations having a processor and local memory providing local storage; and
wherein the LDI Index for the Linked Image Database (LID) is loaded into the respective local memory of the respective local processing subsystem to facilitate selective mapping the Linked Image Database (LID) into the Core Image Database (CID) as needed to provide content needed to provide the display presentation locally at the respective separate location on the respective local processing subsystem.

16. The system as in claim 15, wherein a plurality of people who each provide a respective one of a plurality of LIDs which are utilized by the image mapper in providing the display presentation.

17. The system as in claim 14, wherein the Core Game Application Logic is comprised of a plurality of logical portions of Core Game Application Logic,
wherein the communications interface provides for coupling of software for Linked Game Application Logic (LGAL) and an associated index providing mapping of portions of the LGAL to respective ones of the plurality of logical portions of the Core Game Application Logic; and
the system further comprising:
means for linking the respective portions of the CGAL and portions of the LGAL, responsive to the associated index, to provide an integrated game application logic software program for the video game entertainment product.

18. The system as in claim 14, wherein there are a plurality of the Linked Image Databases (LIDs) coupled to the system; and
wherein the system provides for providing a family of a plurality of video game entertainment products, each of the family of the plurality utilizing a common identity game structure supportive of a common single development environment with each of the plurality utilizing a different one of the plurality of the Linked Image Databases (LIDs) responsive to the LDI Index to provide for a related display presentation.

19. The system as in claim 14, wherein the Core Game Application Logic is comprised of a plurality of logical portions of Core Game Application Logic;
wherein the communications interface provides for coupling of software for Linked Game Application Logic (LGAL) and an associated index providing mapping of portions of the LGAL to respective ones of the plurality of logical portions of the Core Game Application Logic;
wherein the CGAL is comprised of a CGAL Fixed portion (CGALF) and a CGAL Variable portion (CGALV);
the system further comprising:
a Linked Application Database representative of a plurality of linked application portions of the respective LGAL;
a core game application mapping index for mapping each of the plurality of linked application portions for linkage to respective ones of the CGALF portions and CGALV portions;
linkage logic responsive to the associated index for the CGAL, for linking selected ones of the linked applications portions with selected ones of the logical portions of the CGALF portion and CGALV portion, to create an integrated Operational Game Application Logic Software Program; and
wherein the image-mapper provides for linking of a proper location in the LID relative to a respective location in the CID, responsive to the mapping index.

20. The system as in claim 14, wherein there are a plurality of LIDs provided by respective ones of a plurality of people, and
wherein the image-mapper provides for linking of respective locations in the plurality of LIDs relative to respective locations in the CID, responsive to the LDI.

21. The system as in claim 14, wherein the display presentation is comprised of at least in part of an advertisement generated responsive, at least in part, to the LID.

22. A method for providing an environment for integrating work from a plurality of people in creating a video game having an associated video game display presentation, the method comprising:
providing video game core logic for providing for a respective display presentation associated with the video game;
providing a Core Image Database (CID) comprising a core set of video image data and audio image data in a structure comprising a Core Image Database Fixed portion (CIDF) comprising at least one of CIDF video image data and CIDF audio image data and a Core Image Database Variable portion (CIDV) comprising at least one of the CIDV video image data and CIDV audio image data;
providing an image-mapper to control managing and selecting of at least one of video image data and audio image data from a combination of the CIDF portion and the CIDV portion, to provide all content needed by the video game core logic to provide the display presentation;
providing a plurality of Linked Image Databases (LID), one LID for each respective of the plurality of people, wherein each of the LIDs is comprised of at least one of LID video image data and LID audio image data; and
providing for replacement, responsive to the image-mapper, of at least one of the video image data and audio image data from the combination of the CIDF portion and the CIDV, as otherwise associated with the video game, with at least one of the respective LID video image data and the respective LID audio image data from the respective one of the plurality of LIDs, while retaining the video game logic associated with the video game.

23. The method as in claim 22, wherein each said LID has an associated Linked Database Index (LDI), the method further comprising:
utilizing the image-mapper to integrate a combination of the CID and the respective LID responsive to the respective associated LDI, to provide content for the display presentation.

24. The method as in claim 21, wherein each of the LIDs is further comprised of a plurality of Linked Program Data (LPD) portions;
wherein the respective LDI is further comprised of an LPD Index mapping respective ones of the LPD portions for linking and integration into the game core logic;
wherein each of the LPDs is linkable for integration as a respective portion into the game core logic; and
the method further comprising:
linking selected ones of the plurality of LPD portions with respective portions of the game core logic responsive to the respective LPD Index, to provide an output of an integrated game core logic program for a respective integrated video game.

25. A system for development of a video game, the system comprising:
a processing subsystem;
a display generation subsystem;
specific Core Game Application Software written for a target genre of game;
wherein said Core Game Application Software is further comprised of image-mapper logic which defines specific locations in the Core Game Application Software utilizing a structured image database content;
wherein the image-mapper logic controls selection of content from the structured image database content;
a communications interface for coupling a separate respective Linked Image Database (LID) having an associated Linked Database Index (LDI);
wherein the structured image database content is comprised of a Core Image Database (CID) utilized in conjunction with the separate respective Linked Image Database (LID) and the associated Linked Database Index (LDI); and
wherein the image-mapper logic manages indexing and accessing images as necessary to couple the content from the LID, to replace a respective part of the CID of the structured image database, to provide, at least in part, content for a respective video game presentation for a respective video game.

26. The system as in claim 25, further comprising:
means for coupling the LID to the system via on-line linkage; and
providing for selective integration and selective mapping of a respective part of the LID into a respective part of the CID, responsive to the mapping index.

27. The system as in claim 25, further comprising:
means for selectively updating said LID via on-line linkage; and
means for providing new content for integration in the display presentation as at least one of a reward, an advertisement, a substitute character, additional scenery, weapons, clothing, vehicles, music, music video, dance video, exercise video, movie trailers, animated short, an interactive performance of music composition performance, and a change of at least one color in the display presentation of the video game, responsive to the updating.

28. The system as in claim 25, wherein there are a plurality of LIDs, each having a respective associated LDI, the system further comprising:
means for coupling the LIDs to the system via on-line linkage; and
providing for integration and mapping of selected ones of the LIDs into the CID responsive to the mapping index.

29. The system as in claim 25, wherein there are a plurality of LIDs, each having a respective associated LDI, the system further comprising:
means for selectively updating at least one of said LIDs via on-line linkage; and
means for providing new content for integration in the display presentation as at least one of a reward, an advertisement, a substitute character, additional scenery, weapons, clothing, vehicles, music, music video, dance video, exercise video, movie trailers, animated short, an interactive performance of music composition performance, and a change of at least one color in the display presentation of the video game, responsive to the means for updating.

30. The system as in claim 30, further comprising:
means for updating a plurality of the LIDs via on-line linkage; and
means for providing new content for integration into the display presentation responsive to the means for updating.
